(19) United States
(12) Patent Application Publication
(10) Pub. No.: US 2002/0138842 A1
(43) Pub. Date: Sep. 26, 2002

(54) Interactive multimedia video distribution system

(76) Inventors: James I. Chong, Alexandria, VA (US); Brian K. Petitt, Springfield, VA (US); Samuel K. Park, Arlington, VA (US)

Correspondence Address: GARDNER, CARTON & DOUGLAS, PATENT DOCKET DEPT., 321 N. CLARK STREET - SUITE 3400, CHICAGO, IL, 60610, US

(21) Appl. No.: 09/736,275

(22) Filed: Dec. 15, 2000

Related U.S. Application Data
(60) Provisional application No. 60/172,449, filed on Dec. 17, 1999.

(51) Int. Cl. H04N 7/18; H04N 7/173

(52) U.S. Cl. 725/87; 725/91; 725/78

(57) ABSTRACT

The present invention provides a multimedia system that delivers all of the traditional features of a video distribution system including access, control and monitoring of remote cameras, with added benefits for interactive visual communications, including video conferencing, multicasting, broadcasting, data collection and data transfer. There is no need for routing special cabling or additional wiring because the existing network cabling and equipment are utilized. Therefore, implementation costs are minimized. The present invention provides on-demand dial, control and view of multiple cameras. Additionally, the present invention provides on-board video conferencing capability, remote management capability and priority level and control management. Additionally, the present invention is standards based and provides real-time access of multiple cameras and maximizes the use of COTS.

This application claims benefit of U.S. Provisional Application Ser. No. 60/172,449, filed Dec. 17, 1999.

### FIELD OF THE INVENTION

The present invention relates generally to the field of video communications technology. More specifically, this invention is directed to a method and system for dynamically and remotely accessing local and wide area elements real-time and interfacing with an end-user population.

### BACKGROUND OF THE INVENTION

There is an ever-growing need for real-time access, control, and delivery of live video images with audio and data for face-to-face discussions and interactive multimedia applications by means of uni-directional and bi-directional transmission of images and sounds across a variety of transmission medium and schemes.

Presently, the technology available suffers from limitations in transmitting large bandwidth applications, such as transmitting video over a network and also at the same time, being able to combine existing components in this field to allow flexible, cost effective means to create a centrally managed system that guarantees high-quality, interoperable, open-architecture, delivery and distribution system. Most of the existing methods to support real-time video, audio, and multimedia images require a relatively proprietary or closed-architecture approach to deliver high bandwidth or interactive communication sessions. Additionally, these systems require the selection of either routing of special coax cables and additional wiring for video delivery or by utilizing bandwidth on data networks, such as, but not limited to, Ethernet, ATM and Token Ring.

One such prior art system is disclosed in U.S. Pat. No. 5,509,009 to Laycock et al. A dial-up aural and visual communication system includes a telecommunication network with a switch connected thereto, a codec subsystem connected to the switch and video equipment connected to the switch via the codec subsystem with voice communication equipment connected directly to the switch. The codec subsystem is shared between several end users and can be located near the switch. Sharing the codec reduces cost and amount of equipment at end users desk. The codec subsystem can also switch video, including composite video, between local lines and can include frame and storage. The codec can transmit at 9.6 kbps, p×64 kbps, and via ISDN. The system can be used for video conferencing, remote surveillance or desk-top services, and can include an image grooming system. Images may be stored in switch facilities traditionally used for voice mail.

Another prior art system is disclosed in U.S. Pat. No. 5,014,267 to Tomkins et al. communications networks for interfacing between remote video terminals is that provides video, audio and data paths there between. The video terminals transmit and receive video, audio and data information through the network. The network includes a centrally disposed switching network for receiving audio and video information on one of a plurality of audio/video ports and selectively interconnecting this information to one or more of the remaining audio/video ports.

U.S. Pat. No. 5,534,914 to Flohr et al discloses a videoconferencing network for digital computer workstations that operate on a local area network (LAN) to exchange data. The network includes a signaling local area network (A-LAN), connected to a first port of a plurality of workstations, for transmitting and receiving data signals between selected ones of the workstations and a broadband local area network (B-LAN) connected to the second port of the plurality of workstations, for transmitting and receiving television signals between selected ones of these workstations. Each television signal is transmitted at a selected frequency channel so that no two transmissions interfere. A software program, stored in and operable on the computer of each workstation, generates and receives data messages, transmitted via the (A-LAN), to and from the computer of another workstation, respectively. These data messages initiate and control the transmission of the television signals on the (B-LAN) such that a plurality of television signals are assigned to a separate frequency channel. The software program in each computer monitors the status of the channel allocations and generates the channel selecting control signals.

U.S. Pat. No. 5,621,455 to Rogers et al discloses an apparatus and method is provided for modulating and transmitting full-motion, television-quality color video signals along with digital data signals over a pair of ordinary unshielded twisted pair telephone wires without interfering with normal telephone data on the wires without interfering with normal telephone data on the wires. The invention is characterized by a transmission method involving frequency modulation of a baseband video signal and subsequent signal filtering to suppress an upper sideband corresponding to a color component of the original video signal. The filtered signal is received from the telephone wires at a different location, filtered, demodulated and provided to a display device. Full-duplex operation over the same pair of wires is possible, such that two video signals may be simultaneously transmitted, each signal having an approximate bandwidth of 6 MHz and shifted to a desirable non-interfering frequency location within the approximately 20 MHz of usable bandwidth on the telephone wires. No pre-emphasis or de-emphasis is required to achieve good quality video transmission. The system has many applications including video distributions, conferencing, and communications.

However, these prior art devices are limited by what communications methods are available, what infrastructure is in place, what type of platforms are on the PCs or workstations, what format the video or audio is in (digital or analog) nor what network is being used (Ethernet, Token Ring, ATM, etc.)

### SUMMARY OF THE INVENTION

The foregoing limitations and disadvantages of the prior art are overcome by the present invention. This invention provides for an Interactive Multimedia Video Distribution System, that is as centrally manageable system that can utilize various methods, such as digital or analog, to deliver the best-quality video to and from single or multiple elements within the system. This invention also offers a fully adaptable communications system by utilizing both RF and/or IP for delivery of any content including voice, video and data. The present invention is an open-architecture based solution that realizes cost savings in multiple facets.

The IMVDS of the present invention delivers all the traditional features, including access, control and monitoring of remote cameras, with added benefits for interactive visual communications, including video conferencing, multicasting, broadcasting, data collection and data transfer. This platform eliminates the requirement of routing special coax cables and additional wiring for video delivery, by utilizing existing network cabling and by interfacing with existing cameras and equipment. Therefore, implementation costs associated with expensive cabling and network installations normally incurred in renovation and reconstruction are minimized. The open architecture system of the present invention utilizes software driven control graphical user interfaces (GUIs) based on a standard Microsoft Windows™ or similar platform. The video quality of the present invention is guaranteed from remote sites based upon the bandwidth utilized to send video images from the remote cameras or devices. The system of the present invention eliminates the bandwidth bottlenecks associated with traditional systems by utilizing available infrastructure wiring instead on running video on the data network. The present invention also utilizes the existing infrastructure such as cameras, encoders, modems, etc., thereby eliminating extra costs.

The present invention provides on-demand dial, control and view of multiple cameras. The present invention provides controlled access, security functions and video sharing capabilities with other users. The present invention also provides on-board video conferencing capability, remote management capability and priority level and control management. Additionally, the present invention is standards based, provides real-time access of multiple cameras and maximizes the use of international standards such as H.320, H.323, H.324, H.32X, MPEG, etc., and commercial of-the-shelf products (COTS).

The present invention implements two of the most widely accepted forms of signal processing, digital and analog, to maximize the flexibility and efficiency of the system. The present invention combines IP (Internet Protocol) and RF (Radio Frequency) for delivering content to and from devices and is flexible so that the specific application will benefit from either method of signaling dependant upon all variables in their network.

### BRIEF DESCRIPTION OF THE DRAWINGS

The above and other advantages of the invention will be more clearly appreciated from the following detailed description when taken in conjunction with the accompanying drawings in which:

FIG. 1 is a basic illustration a hardware configuration of a real-time system of the present invention.

FIG. 2 is a block diagram illustrating the hardware configuration according to the embodiment in FIG. 1.

FIG. 3 is another embodiment of the real-time system of the present invention illustrating a typical IMTS layout.

FIG. 4 is another embodiment of the real-time system of the present invention.

FIG. 5 is another embodiment of the real-time system of the present invention.

### DETAILED DESCRIPTION OF THE INVENTION

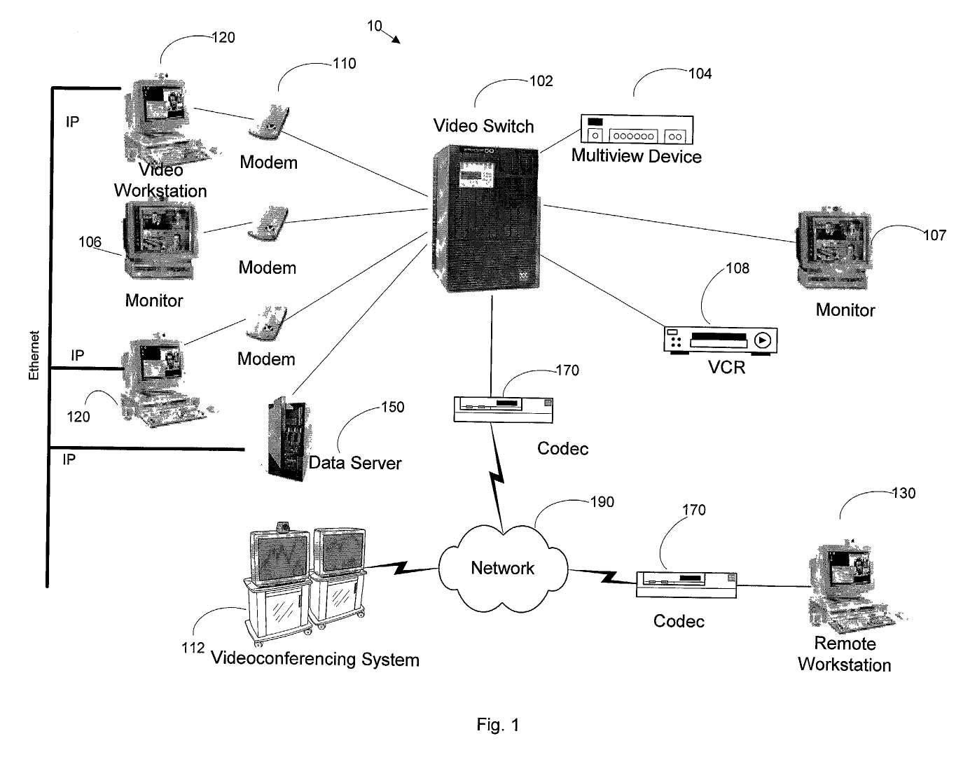

FIG. 1 illustrates a basic arrangement of the IMVDS (10). The system comprises a network communications central unit switch (102) that is capable of connecting at least approximately 256 endpoints, modems (110), video workstations (120, 130), data server (150), codec subsystem (170), VCR (106), multi-view device (104), videoconferencing system (112), network interface (180) and monitor (106). Video workstations (120, 130) are capable of audio and visual communications.

The central unit switch (102) is a bidirectical network communications hub and works by routing RF modulated signals and is capable of carrying multiple audio, video, and data signals to and from different ports. The data server (105) administers management of the present invention. The video workstations (120, 130) comprise hardware and software that controls the processing of data received. The application software at the video workstation controls the flow of data to and from the central unit switch (102) via a multimedia interface device and can communicate with any device or stations connected to the switch (102) such as a modem for transmitting data by, for example integrated switched digital network (ISDN) modem.

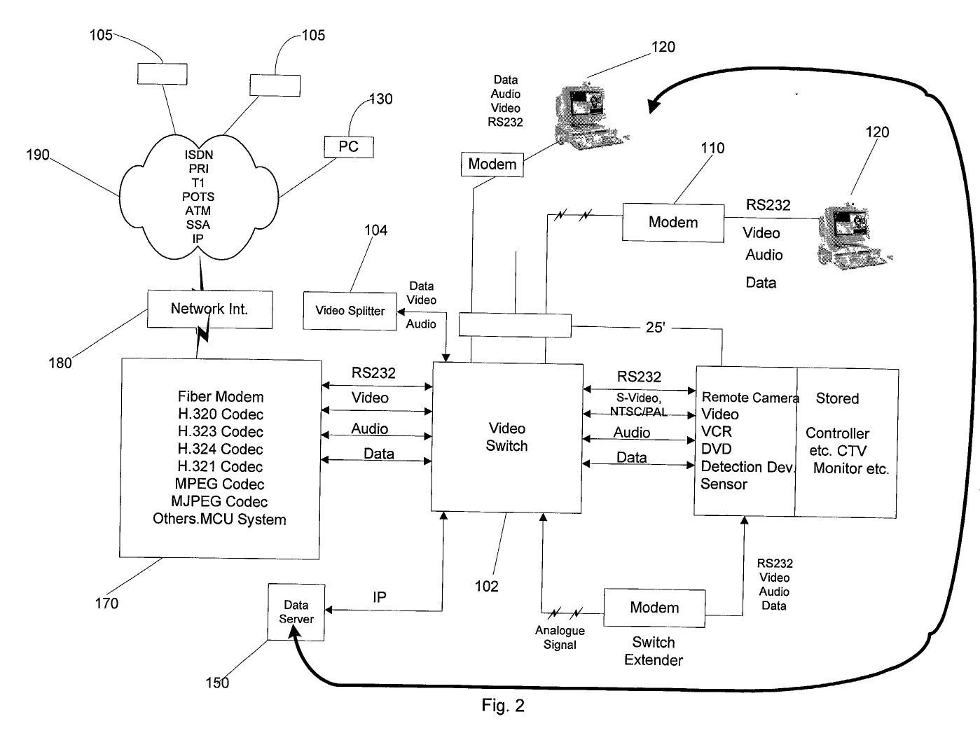

Turning to FIG. 2, video workstation (120), remote camera (105), VCR/DVD, detection device (107) and the sensor (108) each communicate with the central unit switch (102) via any known means such as RS232, Video (NTSC/PAL), audio or data. Video workstations (120, 130) access the central unit switch (102) via a modem (110). Video workstations (120, 130) are interactive and interoperable with each other through the central unit switch (102) and the data server (105) and with any other device in the network for the network for video communications. The video workstations (120, 130) include microphones and speakers for transmitting audio communications.

The codec subsystem (170) may include any standards-based codecs including a multipoint control unit (MCU) system that is capable of housing several different codecs, in order to be able to provide a number of services for a number of different types of end uses. The codec subsystem (170) is in communication with the central unit switch (102). Numerous codecs may be installed within the subsystem (170), depending upon the service to be supported.

The codec subsystem (170) allows remote communication via the network interface (180). The network interface (180) provides an interface to communication network (190). Communication network (190) may be multiple types of combinations of network architectures, including ISDN, a wireless network, a LAN, a WAN, a Community Access Television Network (CATV), the Internet, an ATM network, T1 and the Public Switched Telephone Network (PSTN). However, it will be apparent to those skilled in the art that other types of communications protocols are suitable for use with the present invention.

The video splitter (104) is used to deliver multiple video images in a single display on a single computer monitor simultaneously, without an external monitor or video displays. Modem (110) is used as a switch extender to allow communication in excess of 25 ft. The data server (150) provides standardized database functioning and flexibility. The data server (150) allows elements in IMVDS architecture of the present invention to function including the management capability, system status, and all IP communication to and from different ports, including the video stations and the central unit switch (102). Data may also be stored in the data server for different applications such as a database.

The network communications central unit switch (102) is, for example, a multifunction broadband switch that delivers two-way, full-motion video having audio and high-speed data communications capabilities. The central unit switch (102) delivers multimedia communications using twisted pair wiring or the like. The central unit switch (102) is compatible with digital analog and standards, such as ISDN. The data server (150) interfaces with the central unit switch (102) and the video stations (120, 130) in administration of the system. The data server (150) manages user priorities including database management and camera location information. The data server (150) connects the video workstations (120, 130) via IP or other connection.

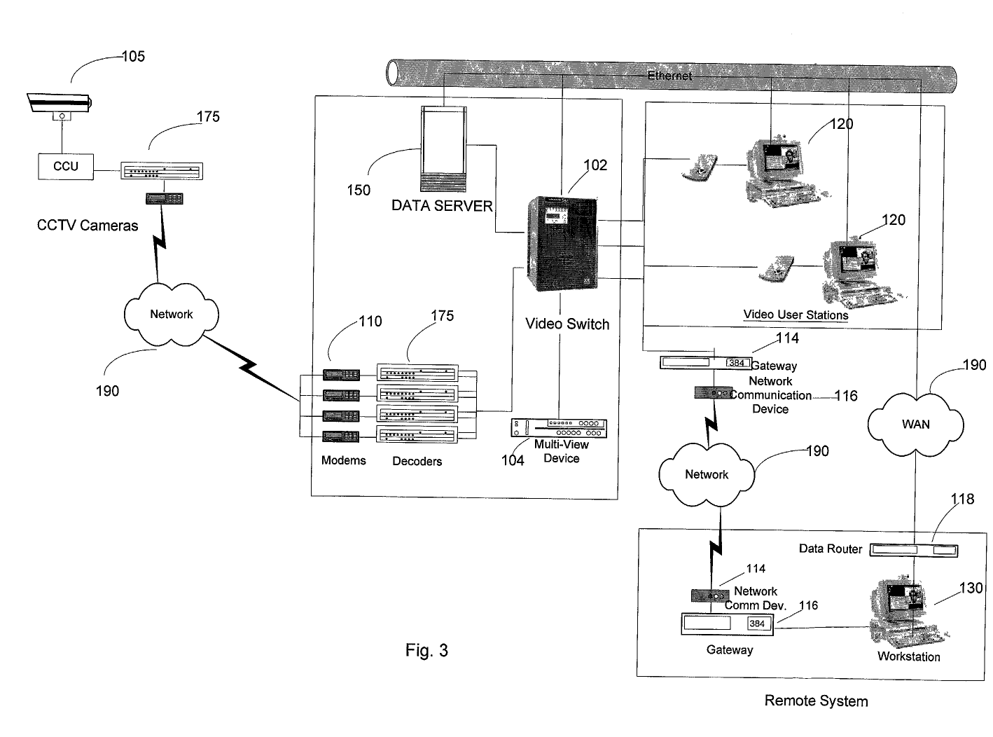

Referring now to FIG. 3, there is shown a diagram of another embodiment of the real-time video system of the present invention. The basic system layout includes the network communications central unit switch (102) connected to the data server (150) and video user stations (120) via modems (110), multi-view device (104), codec subsystem (170), and network communication device (116) gateway device (114). The video user stations are comprised of video workstations (120,130). The central unit switch (102) communicates to the remote system via communications network (180, 190). The remote system is comprised of network communications device (116), gateway (114), remote workstation (130) and data router (118). The video workstations (120, 130) also communicate to the remote system via WAN (190). The central unit switch (102) communicates to the remote cameras (105) thought codec subsystem (170), modems (110) and network (180).

FIG. 3, an example of an Intelligent Traffic Management System (ITMS) used in a Traditional Traffic Management Center (TMC), is a preferred embodiment of the present invention. In networked surveillance operations, when video data is sent from remote camera (104), for example a highway traffic surveillance camera, the dynamic real-time images are transmitted to the various peripheral devices via the network switch (102). The switch determines to which device the video data is directed. If the video data or audio data (image or voice) is directed to video workstation (120), the data is processed by the interface via the modem and output to the video workstation. If video workstation (120) has command control and data to transmit to the remote camera (104) for controlling the operation of the camera, the data is directed to the interface card and is sent via modem (110) to the network switch (102) which processes the data for communication with the remote camera (104). The maximum transport distance for the system disclosed in FIG. 3 is 2000 feet over Category 5 cabling from the location of the video workstation due to RF cabling losses. For system requirements exceeding 2000 feet, a different configuration is required. The video quality received at the TMC is dependent on the bandwidth utilized to send video images from the remote cameras. The method of delivery may be via methods such as single or multimode fiber, integrated switched digital Network (ISDN) or telephone systems, T1, E2 and PRI.

Referring again to FIG. 3, the ITMS enables users to interact in real time with supporting agencies and organizations, such as fire and rescue centers, highway patrol and other transportation agencies, whether local, national or global, in sharing information to enhance surface transportation management and improve highway safety. Every user on the local or wide area network (LAN/WAN) equipped with the ITMS software, commercial-off-the-shelf (COTS) video package, and appropriate interface card is able to dial, control and view remote highway surveillance cameras. The system is capable of delivering both National Television Standards Committee (NTSC) and phase alteration line (PAL) video signals to the desktop. As requirements arise, real-time video conferencing is also possible with any other user on the network, while viewing live traffic on the same screen for consultation and discussion. This communications platform offers on-demand access and control of video, audio and data devices from a simple user desktop.

As the need arises for other agencies and organizations to access live images from the world's highway systems, this unique traffic management technology will allow even smaller TMCs and jurisdictions to implement a cost-effective system. Major metropolitan city TMCs will be able to support smaller surrounding jurisdictions, by acting as primary video management centers while maintaining full control over all surveillance cameras at all times.

The benefits of ITMS are the ability for any authorized personnel to monitor traffic situations without having to leave the office, and being able to stay abreast of critical highway incidents more effectively, anytime, from anywhere. Another benefit of the ITMS solution is the capability of allowing remote access from other locations to the TMC's video network by implementing a gateway for WAN connectivity.

As well as savings in equipment costs compared with typical traffic management systems, the ITMS realizes cost benefits by maximizing utilization of existing investments, both internal and external to the TMCs. Another great cost saving is operator training. The extremely user-friendly, intuitive-control GUI is based on a standard Windows platform; training required to facilitate the ITMS is therefore greatly reduced for personnel who are familiar with other windows applications. The user can simply follow on-screen help instructions to dial and control highway surveillance and monitoring cameras. All the above-mentioned factors contribute to the realization of cost savings in implementing a PC-based ITMS solution.

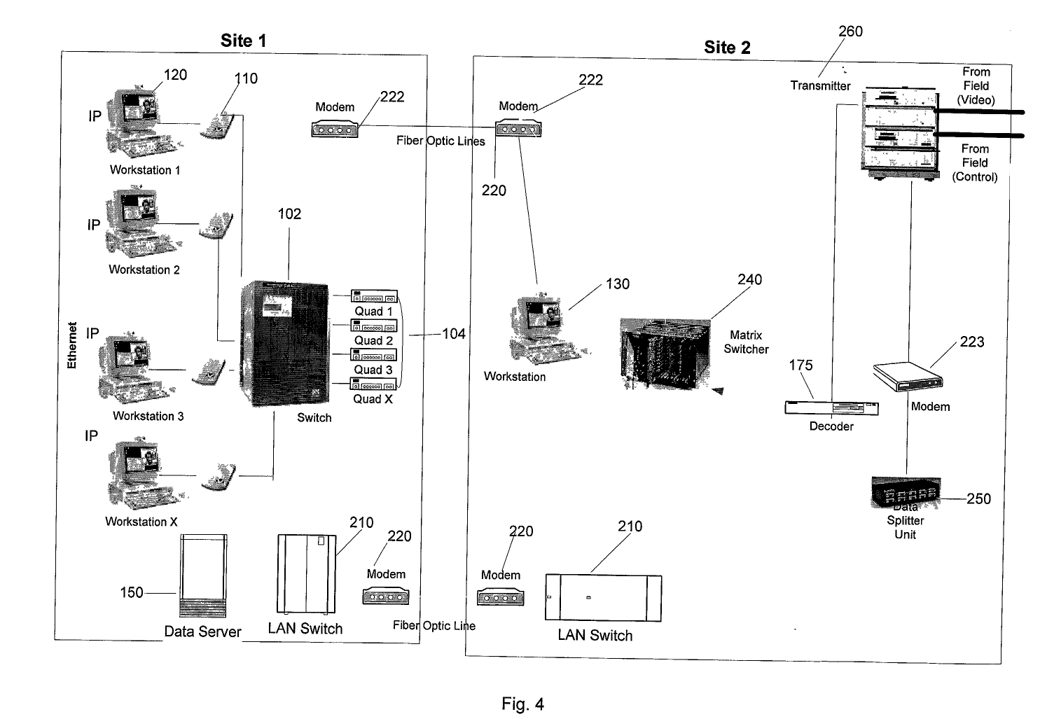

Referring to FIG. 4, there is shown a diagram representing another embodiment of the present invention. In this embodiment, the network communications central unit switch (102) controls at least two locations, Site 1 and Site 2. At Site 1, the central unit switch (102) communicates with video workstations (120,130) via modems (110). Although four video workstations are shown, the system is capable of supporting multiple workstations. The central unit switch (102) is also connected to multi-view devices (104). The video workstations (120,130) are connected directly to the data server (150). LAN switch (210) is connected to the central unit switch (102) and to modem (220). Modem (220) provides data communication between LAN switches (210). The central unit switch (102) is connected to modem (222). At Site 1, Modem (222) provides video/audio/data communication between Site 1 and Site 2 by communicating with another video/audio/data modem (222) located at Site 2. Remote video workstation (30) is connected to LAN switch (210) and to matrix switcher (240) via modem (222). Although only one video workstation is shown at Site 2, the system is capable of supporting multiple workstations. Matrix switcher (240) is connected to data splitter (250) thru decoder (175). Modem (223) is connected to data splitter (250) and transmitter (260).

In a typical multimedia sessions, transmitter (260) receives video data from a field camera. The data is sent in compressed format to the decoder (175). The decoder (175) converts the data from digital to analog. The data is then sent to the matrix switcher (240). The matrix switch (240) routes the data to the central unit switch (102) via modem (222). Video workstations (120,130) then have access to the data. The video workstations located at Site 1 communicate with the remote video workstations. All workstations are capable of accessing and controlling all elements in system. Data Splitter (250) controls the data sent to the field cameras.

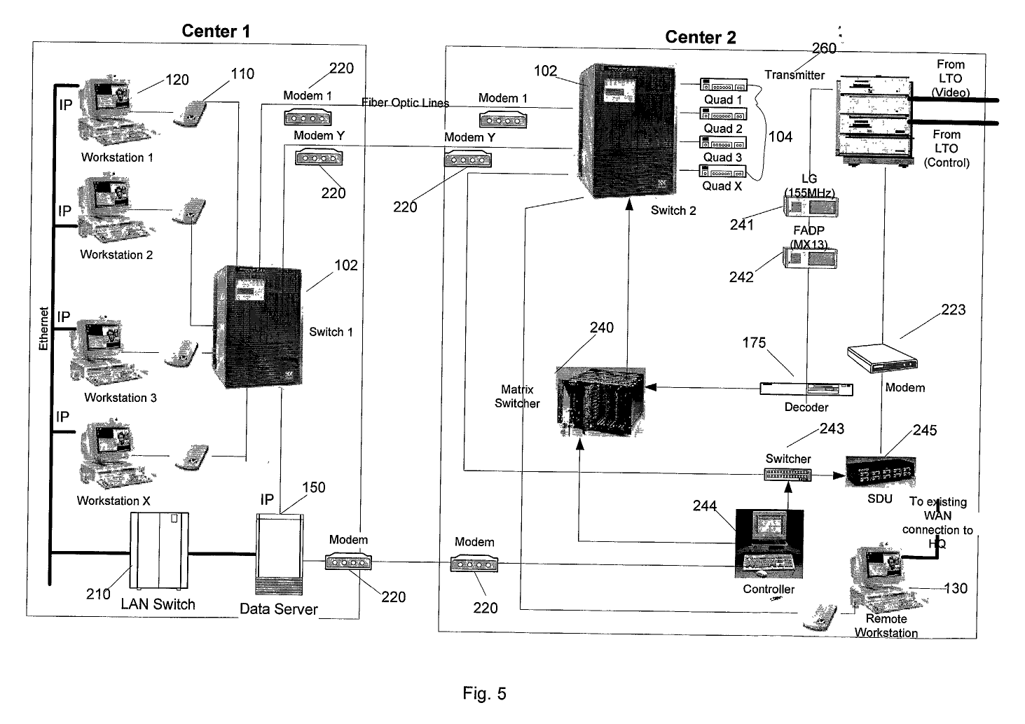

Turning to FIG. 5, there is a hardware configuration of another embodiment of the real-time video system of the present invention. FIG. 5 shows data conferencing between two centers, Center 1 and Center 2. Center 1 has a network communications central unit switch (102), modems (110) video workstations (120,130), LAN switch (210), data server (150) and modems (220). Center 2 has a network communications central unit switch (102), fiber modems (220), multi-view devices (104), matrix switcher (240), controller workstation (244), switcher (243), SDU (245), decoder (175), modem (223), FADP (242), LG (241) and transmitter (260). The embodiment of FIG. 5 differs from that of FIG. 4 in that Center 2 is provided with another central unit switch (102). Trunking the two central switches doubles the capacity of the system.

The present invention utilizes existing equipment that is commercially available by combining, interconnecting and arranging the equipment together to allow fully interactive (one-way, two-way and multi-way) and multimedia (audio, video and data) communication to occur. The present invention also utilizes a new combination of separate features such as video codecs, video switches, PCs, Network Interfaces, communication modems/devices, and video splitters and combines them into an interactive multi-media solution.

The present invention is an open system architecture based on International Telecommunications Union (ITU) standards and commercial-off-the shelf products (COTS), which ensures that the system is capable of adopting many of the popular digital transmission formats, including M-JPEG, MPEG1 and MPEG2. Once the real-time video data is brought into the TMC, the video data may be distributed via a building or campus LAN wiring for simultaneous viewing by multiple video workstations. The video distribution platform enables delivery of real-time, uncompressed video over twisted pair or any unshielded twisted pair category 3, 4 or 5 cabling schemes. On networks utilizing category 5 cables, transmission is via the spare pair wires that are generally available on most networks.

Although a remote virtual access system for automobile traffic video surveillance has been exemplified, the architecture described is capable of supporting other applications such as, intelligent surveillance, manufacturing plant monitoring, warehouse management systems, telehealthcare/telemedicine, distance learning, travel/hospitality, and surface transportation management centers.

While this invention has been described with specific embodiments, many alternatives, modifications and variations will be apparent to those skilled in the art in light of the foregoing description. Accordingly, it is intended to include all such alternatives, modifications and variations set forth within the scope of the description.

We claim:

1. A multimedia distribution system comprising:
(a) a communications switch;
(b) at least one network interface device connected to the communications switch;
(c) a first workstation connected to the switch;
(d) a data server connected to the switch;
(e) a first codec connected to the switch; and

2. The multimedia distribution system of claim 1 further comprising a second video workstation; a second codec connected to the second video workstation; and wherein the second workstation communicates with the first workstation via a communications network.

3. The multimedia distribution system of claim 2 wherein the communications network is selected from the group comprising ISDN, Ethernet, Token Ring, ATM, IP, Wireless, Telephone or T1.

4. A remote virtual access system comprising:
(a) a multifunctional bidirectional communications switch;
(b) at least one decoder connected to the switch;
(c) a data server connected to the switch;
(d) a first video workstation connected to the communications switch;
(e) at least one multiview device connected to the communications switch; and
(f) at least one image transmitting device connected to the communications switch;

5. The remote virtual access system of claim 4 wherein the first video workstation communicates with the communications switch via a network interface device.

6. The remote virtual access system of claim 4 wherein the image transmitting device communicates with the switch via a communications network.

7. The remote virtual access system of claim 6 wherein the communications network is selected from the group network is selected from the group comprising ISDN, Ethernet, Token Ring, ATM, IP, Wireless, Telephone or T1.

8. The remote virtual access system of claim 4 further comprising a second workstation and wherein the second workstation communicates with the first workstation or the image transmitting device or the communications switch via a communications network.

9. A multimedia information access service comprising:
a first system comprising:
(a) a first communications switch;
(b) a first workstation connection to the communications switch;
(c) a data server connected to the first communications switch;
a second system comprising:
(a) a second communications switch;
(b) a device for transmitting signals to the communications switch;
(c) a device for converting signals, the device in communication with the transmitting device; and
(d) at least one network interface device wherein the network interface device transmits signals from the first system to the second system.

10. The multimedia information access service of claim 9 further comprising a LAN switch connected to the data server.

11. The multimedia information access service of claim 9 further comprising at least one multiview device connected to the second communications switch.

12. The multimedia information access service of claim 9 further comprising a second transmitter connected to the second communications switch.

13. The multimedia information access service of claim 9 wherein the second transmitter receives data from a remote image transmitting device.

14. The multimedia information access of claim 13 wherein the first workstation is adapted to communicate with the image transmitting device.

15. The multimedia information access service of claim 11 wherein the multiview device is adapted to transmit multiple images to the first workstation.

16. The multimedia information access service of claim 13 wherein the second transmitter is adapted to transmit data to the remote image transmitting device.

17. A method of distributing information comprising the steps of:
(a) transmitting video signals from an image transmitting device;
(b) sending the video signals over a communications network to a decoder;
(c) converting the video signals at the decoder;
(d) transmitting the converted video signals to a workstation via a communication switch;
(e) displaying the video signals at the workstation; and
(f) transmitting the video signals to a second workstation via the communications network.

18. A method of distributing real-time multimedia information comprising the steps of:
(a) receiving compressed digital video data signals;
(b) decompressing the video data signals;
(c) converting the video data signals from digital to analog;
(d) transmitting the video data signals to a first communications switch via a network interface;
(e) receiving the video data signals at a second network interface;
(f) transmitting the video data signals to a workstation; and
(g) displaying the video data signals at the workstation.

19. The method of claim 18 further comprising the steps of:
(h) manipulating the video data signals at the workstation;
(i) transmitting the manipulated video data signals to an image transmitting device.

20. The method of claim 19 wherein the manipulated video data signals are adapted to control the image transmitting device.
